(19) United States
(12) Patent Application Publication
(10) Pub. No.: US 2012/0007898 A1
(43) Pub. Date: Jan. 12, 2012

(54) INFRA-EXTENSIBLE LED ARRAY CONTROLLER FOR LIGHT EMISSION AND/OR LIGHT SENSING

(75) Inventor: Mark J. Pavicic, Fargo, ND (US)

(73) Assignee: NDSU RESEARCH FOUNDATION, Fargo, ND (US)

(21) Appl. No.: 13/184,258

(22) Filed: Jul. 15, 2011

Related U.S. Application Data
(63) Continuation of application No. PCT/US2010/022643, filed on Jan. 29, 2010.
(60) Provisional application No. 61/148,474, filed on Jan. 30, 2009.

(51) Int. Cl. G09G 5/10; G09G 3/36

(52) U.S. Cl. 345/690; 345/87

(57) ABSTRACT

An apparatus for controlling light emission and/or sensing in an array of optical elements. An infra-extensible array having a plurality of subarray display circuits interconnected with neighboring subarray display circuits. Each subarray display circuit is configured with a processor and a plurality of output and/or input elements. Messages and instructions can be propagated from one subarray display circuit to another to provide local processing relating to input and output elements, such as changing the pixels in the display from a subarray display circuit in response to locally sensed conditions or those communicated from neighboring subarray display circuits. Apparatus is infra-extensible as both the number of processors for executing display/sensor programming, and the number of communication channels available through which instructions can be received, increases automatically in response to increasing the number of subarray display circuits within the apparatus.

### CROSS-REFERENCE TO RELATED APPLICATIONS

This application a 35 U.S.C. §111(a) continuation of PCT international application serial number PCT/US2010/022643 filed on Jan. 29, 2010, incorporated herein by reference in its entirety, which is a nonprovisional of U.S. provisional patent application 61/148,474 filed on Jan. 30, 2009, which is incorporated herein by reference in its entirety. Priority is claimed to each of the foregoing applications.

The above-referenced PCT international application was published as PCT International Publication No. WO 2010/088553 published on Aug. 5, 2010 and republished on Nov. 18, 2010, and is incorporated herein by reference in its entirety.

### STATEMENT REGARDING FEDERALLY SPONSORED RESEARCH OR DEVELOPMENT

This invention was made with Government support under Grant No. H94003-06-2-0603 and Grant No. H94003-07-2-0707 awarded by DMEA. The Government has certain rights in this invention.

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to display and sensor arrays, and more particularly to an extensible array of processor controlled subarray display circuits adapted for controlling light emission and/or light sensing functions thereof.

2. Description of Related Art

Light-emitting diodes (LEDs) are commonly used in array configurations to create displays, including both indoor and outdoor displays of various sizes. Within typical displays, LED activity is typically controlled in response to a scanning process whereby only a portion of the LEDs are active at any given time, such as exemplified by scanning LEDs in a row and column format. Successive rows of LEDs within the display are activated to cause a single frame of an image to be displayed. Scanning in this manner is performed sufficiently rapidly (e.g., high refresh and/or scan rate) so that it is preferably not perceived by the human eye. However, in response to an insufficient scan rate, the display will appear to “flicker”.

If the number of rows in the display is increased, such as in creating a larger or higher resolution display, then the scan time per row must be decreased to sustain a given frame rate. Reducing LED ON-times, for a given LED current, reduces perceived brightness of the LED. Although the perceived loss in brightness can be partially compensated by increasing current levels through the LED, there is a finite limit as to how much current an LED can dissipate without damage. In addition, when LEDs are subject to high ambient lighting conditions, any loss of brightness can be problematic. In either case, the dimensions of a scanned LED display are limited with respect to achieving a desired image intensity.

Toward overcoming the scan limitations, certain displays activate multiple display rows simultaneously to effectively scan multiple portions, or strips, of the display at the same time.

In considering the circuitry for controlling the LED array of a display or display strip, it will be recognized that circuitry is associated with each row and column of LEDs in the display. As the number of rows or columns is increased, the amount of circuitry must also increase. Display array designs can be configured so that the row and column drivers support a finite range of array sizes. However, as the horizontal dimension is increased, the number of LEDs per row increases, which increases the current demands on the row controllers. As the current capacity of the row controllers is limited, the practical width of the display (or strip within the display) is also limited.

Accordingly, a need exists for a system and method of driving LED display arrays of arbitrary size without undue loss of display intensity or introduction of flicker. These needs and others are met within the present invention, which overcomes the deficiencies of previously developed display array apparatus and methods.

### BRIEF SUMMARY OF THE INVENTION

This invention is an extensible display array on which optical output and/or light sensing is controlled in response to distributed execution across an array of interconnected subarray display circuits. Applications include, but are not limited to, optical displays (e.g., LED), sensor arrays (e.g., light, radiation, temperature, acoustic energy, etc.), sensing displays, and selective backlighting.

A display is formed according to the present invention in response to interconnecting a plurality of subarray display circuits, each comprising a computer processor and associated memory, as well as a plurality of optical elements, such as light emitting diodes (LEDs). Infrastructural aspects of the present invention provide unique extensibility mechanisms which provide numerous benefits to be described.

A typical display array is extended in terms of its area (e.g., length and width) and for which it is necessary to extend power to each of the devices while maintaining a means for communicating display data. However, typical approaches lack a structure which fully supports the extension whereby as the array size increases it becomes increasingly difficult to support fast refresh cycles. So as the size increases in a typical display, the responsiveness of the display decreases.

The present invention, however, moves beyond the shortcomings of these typical display array approaches, as its underlying infrastructure provides what is referred to herein as “infra-extensibility”, in which both processing power and communication throughput extend automatically in response to display size increases. This is made possible as each subarray element contains its own processing and local communication so that as the display size increases, the amount of processing power increases accordingly. In addition, the communication structure is configured so that information can be received by any processor of a subarray display circuit, or combination of subarray display circuit processors thereof, which are located anywhere about the periphery of the display and/or sensor array, whereby the overall communication throughput increases in response to array size increases.

The term “local” is utilized with respect to the display and/or sense array apparatus to refer to actions which are performed in response to local control by a single subarray display circuit, or a cooperative action between interconnected subarray display circuit controllers without the need of control decisions being communicated outside of the array of subarray display circuits, such as to a separate external display controller. Communication to an external controller is not considered “local” according to the teachings of the present invention. Typical display and/or sense arrays do not have the ability to modify display output or sense detection in response to conditions which are determined local to a portion of the array. It should be appreciated, however, that the ability to perform “local” actions does not preclude the array embodiments according to the present invention from also communicating to external devices (outside of the array of subarray display circuits) or performing actions in response to information from external devices.

The on-board display processing also allows display and/or sensor arrays according to the present invention to process higher level information, such as vector representations and any desired abstractions, by utilizing its abundant processing and neighbor-to-neighbor processor interaction.

In addition, the structure of the present invention provides localized optical response, in which the display can be updated from local information without the need of communicating information to a remote processor and then propagating its directives back to the correct portion of the display.

By way of example and not limitation, when the inventive display includes light sensing, the structure supports rapid (local) processing of sensed light, such as the detection of laser pointer input, determining positions of one or more persons viewing the display, or in response to ambient lighting conditions. The display output can be changed locally by subarray processors in response to the light detected on a given subarray display circuit and any desired extent of neighboring subarray display circuit processors. Embodiments of the present invention even allow portions of the display to locally update itself, such as in response to registering impinging light from a laser pointer, and furthermore to determine and respond to the direction from which the laser light impinges on the display.

At least one embodiment of the invention describes using an emissive array (e.g., LEDs) as a backlight for a display which has one or more transmissive states in which light is transmitted through the display (e.g., liquid crystal display (LCD)). As a backlight the inventive display is highly-controllable in terms of intensity and optionally as to color (e.g., using multicolor LEDs in the array). In addition, backlighting according to the invention can also provide light-sensing, synthetic aperture imaging, and responsive local control of portions of the display. The light-sensing ability is operable when the associated LCD is at least partially transmissive, or in combination with the LCD used as “shutters” to control the extent to which light is received on the backlight array.

It should be appreciated that although the apparatus and method of the present invention is applicable to controlling an output, input, or combination of output and input array, many of the terms and descriptions recite display aspects in view of present use applications and not with regard to limiting practice of the invention. For example, although the term “subarray display circuit” reflects an optical display application it may be utilized for arrays which provide sensor inputs only, or both outputs and inputs. Still further, the majority of the descriptions refer to the use of optical arrays, however, the invention is not limited to controlling optical arrays.

The invention is amenable to being embodied in a number of ways, including but not limited to the following descriptions.

One embodiment of the invention is an apparatus for controlling light emission in an array of optical elements, comprising: (a) a plurality of optical elements disposed on a subarray display circuit; (b) a plurality of subarray display circuits interconnected into the apparatus to communicate with one another and configured for displaying a light emissive optical output as text and/or graphics; (c) a computer processor and associated memory disposed on each subarray display circuit and coupled to the plurality of optical elements thereon; (d) a plurality of communication channels on the computer processor in which one communication channel is configured for communication with each neighboring subarray display circuit; (e) programming executable on the computer processor for, (e)(i) receiving light emission instructions on each of a plurality of subarray display circuits located on the periphery of the apparatus, (e)(ii) communicating light emission instructions through the plurality of communications channels between neighboring subarray display circuits, and (e)(iii) emitting light from optical elements of each subarray display circuit within the apparatus in response to the light emission instructions.

The apparatus is infra-extensible in that the number of processors for performing the programming, and the number of communication channels available through which the light emission instruction can be received, increases automatically in response to increasing the number of subarray display circuits within the apparatus.

In at least one implementation, the plurality of optical elements are disposed on a first substrate side of the subarray display circuit, and the computer processor is disposed on a second substrate side of the subarray display circuit.

In at least one implementation the communication channels each comprise a one-wire or two-wire communication connection between input/output ports of computer processors disposed on neighboring subarray display circuits.

In at least one implementation, the programming executable on said computer processor is configured for storing optical calibration information, for the optical elements of a subarray display circuit, in a memory associated with the computer processor of each of the subarray display circuits.

In at least one implementation, each optical element comprises at least one optically emissive element within a common housing.

In at least one implementation, at least a portion of the optical elements disposed on the subarray display circuit are configured for selectively registering light intensity or light emission.

In at least one implementation, the plurality of optical elements comprise light emitting diodes (LEDs). At least a portion of the LEDs on the subarray display circuit are configured for selectively registering light intensity or generating light emission.

In at least one implementation, the programming is configured for executing light sensing routines based on light received on at least a portion of the optical elements.

In at least one implementation, the programming is configured for communicating information about the light received to processors located on neighboring subarray display circuits.

One embodiment of the invention is an apparatus for controlling light emission and light sensing in an array of optical elements, comprising: (a) a plurality of optical elements disposed on a subarray display circuit with each optical element configured for emitting light and for sensing light; (b) a plurality of subarray display circuits interconnected into the apparatus to communicate with one another and configured for displaying a light emissive optical output as text and/or graphics; (c) a computer processor and associated memory disposed on each subarray display circuit and coupled to the plurality of optical elements thereon; (d) a plurality of communication channels on the computer processor in which one communication channel is configured for communication with each neighboring subarray display circuit; (e) programming executable on the computer processor for, (e)(i) receiving light emission instructions on each of a plurality of the subarray display circuits located on the periphery of the apparatus, (e)(ii) emitting light from the optical elements of each subarray display circuit within the apparatus in response to the light emission instructions, (e)(iii) detecting light impinging on the optical elements of the subarray display circuits within the apparatus; (e)(iv) communicating light emission instructions and information about detected light through the plurality of communications channels between neighboring subarray display circuits.

One embodiment of the invention is an apparatus for controlling light emission in an array of optical elements, comprising: (a) a plurality of optical elements disposed on a subarray display circuit with each optical element configured for emitting light and for sensing light; (b) a plurality of subarray display circuits, interconnected for communicating with adjacent neighbors, and combined into a combination imager and selective backlight; (c) a selective opacity display configured for displaying an optical output as text and/or graphics, and coupled to the combination imager and selective backlight, in which the selective opacity display has at least one display state in which light is transmitted through the display to, and/or from, the combination imager and selective backlight; (d) a computer processor disposed on each subarray display circuit and coupled to the plurality of optical elements; (e) a plurality of communication channels on the computer processor in which one communication channel is configured for communication with each of the neighboring subarray display circuits; (f) programming executable on the computer processor for, (f)(i) receiving light emission instructions on each of a plurality of the subarray display circuits on the periphery of the combination imager and selective backlight, (f)(ii) emitting light from the optical elements of each subarray display circuit within the combination imager and selective backlight in response to the light emission instructions, (f)(iii) detecting light traversing the selective opacity display and impinging on the optical elements of subarray display circuits within the combination imager and selective backlight; (f)(iv) communicating light emission instructions and information about detected light through the plurality of communication channels between neighboring subarray display circuits within the combination imager and selective backlight.

The selective opacity display may comprise a liquid crystal device (LCD), or similar device. The apparatus comprises an infra-extensible combination imager and selective backlight in which the number of processors for performing the programming and the number of communication channels available through which the light emission instruction can be received, increases automatically in response to increasing the number of subarray display circuits within the combination imager and selective backlight. The present invention provides a number of beneficial aspects which can be implemented either separately or in any desired combination without departing from the present teachings.

An aspect of the invention is an infra-extensible array controller for optical displays and sensing arrays.

Another aspect of the invention is a display array comprising a plurality of interconnected subarray display circuits, each of which contains a computer processor and a portion of total number of optical elements of the overall display and/or sensor array.

Another aspect of the invention is an infra-extensible display and/or sensor array having inputs and outputs subdivided and processed across a plurality of subarray display circuits.

Another aspect of the invention is an infra-extensible display and/or sensor array in which each subarray display circuit is coupled for communicating with at least each of its adjacent neighbors.

Another aspect of the invention is an infra-extensible display and/or sensor array in which external communication is supported to, and from, the plurality of interconnected subarray display circuits at any desired peripheral portions of the display and/or sensor array apparatus.

Another aspect of the invention is an infra-extensible display and/or sensor array which can support the use of either multiplexed or non-multiplexed arrays within the subarray display circuit.

Another aspect of the invention is an infra-extensible display and/or sensor array in which elements of a subarray display circuit can be either directly and/or indirectly controlled by its associated processor.

Another aspect of the invention is infra-extensible array which can provide both optical output and detect optical input over the same array of subarray display circuits.

Another aspect of the invention is an infra-extensible array whose operation can be programmed prior to, or more preferably after, assembling the subarray display elements into a larger array.

Another aspect of the invention is an infra-extensible array in which array positions for each subarray display circuit are determined and stored therein in response to neighbor-to-neighbor communication.

A still further aspect of the invention is an infra-extensible display and/or sensor array which is applicable to a wide range of applications.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1A is an image rendition of a subarray display circuit according to an aspect of the present invention, showing a substrate first side having a four-by-four array of multi-element, multi-color, light emitting diodes (LEDs).

FIG. 1B is an image rendition of a subarray display circuit according to an aspect of the present invention, showing a substrate second side with a computer processor coupled to the LEDs depicted in FIG. 1A.

FIG. 2 is a image rendition of a portion of multiple subarray display circuit according to aspects of the present invention, showing interconnectivity (pseudo-trace) with each adjacent neighbor.

FIG. 3 is a block diagram of a plurality of subarray display circuits having single wire interconnection according to aspects of the present invention, showing designations and a protocol to prevent communication collisions.

FIG. 4 is a schematic of a subarray display circuit according to an aspect of the present invention, showing a microcontroller coupled to an array of optical elements and adapted for communicating with each adjacent neighboring subarray display circuit.

FIG. 5 is a schematic of LED multiplexing referred to herein as “Charlieplexing” shown utilized according to aspects of the present invention.

FIG. 6 is a block diagram of a light emitting and light sensing array according to an aspect of the present invention, showing synchronization of light output and input cycles and localized display change.

FIG. 7 is a schematic of two subarray display circuits according to an aspect of the present invention, shown directly controlling multiplexed optical elements.

FIG. 8 is a schematic of two subarray display circuits according to an aspect of the present invention, shown indirectly controlling multiplexed optical elements.

FIG. 9 is a block diagram of an LCD backlighting embodiment according to an embodiment of the present invention, showing a combination imager and selective backlight coupled to an LCD display.

FIG. 10 is a flowchart of programming executable on a subarray display circuit for controlling display outputs according to an aspect of the present invention.

FIG. 11 is a flowchart of programming executable on a subarray display circuit for controlling display outputs and communicating light detection and processing according to an aspect of the present invention.

FIG. 12 is a flowchart of loading programming within an array of interconnected subarray display circuits according to an aspect of the present invention.

### DETAILED DESCRIPTION OF THE INVENTION

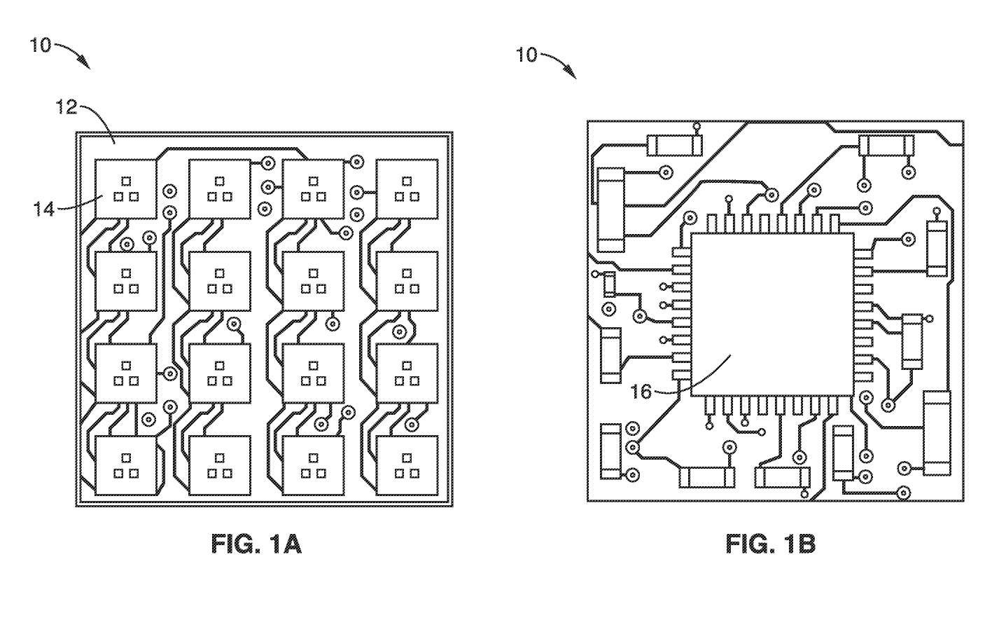

Referring more specifically to the drawings, for illustrative purposes the present invention is embodied in the apparatus generally shown in FIG. 1A through FIG. 12. It will be appreciated that the apparatus may vary as to configuration and as to details of the parts, and that the method may vary as to the specific steps and sequence, without departing from the basic concepts as disclosed herein.

### 1. Introduction to Infra-Extensible Display and/or Sensor Array

In achieving large display sizes one can divide the display into segments. For example, to provide horizontal extensibility of the display, one can create display strips then divide the display strips into horizontal segments in which each segment provides its own row controllers. Segments can be added to extend the horizontal dimension of the display or display strip. The result is that the display becomes an extensible matrix of sub-displays.

It has often been supposed in the art that sub-display sizing would ideally be determined in response to the smallest marketable display within a given display model. In this way a single usable display of a first size, 1X, can then be extended to displays of sizes 2X, 3X, 4X, and so forth as need arises.

The present invention appreciates, however, that benefits can arise in response to making the sub-displays substantially smaller than a conventional full display. By reducing display size sufficiently, row and column control functions (e.g., driving) can be performed by general purpose device circuits which are used in large quantities and thus are available at low cost. In addition, inexpensive control circuit devices provide a limited number of available input and output control lines (I/O pins), and are limited as to the size of the sub-display which can be controlled. If the cost of the device is sufficiently low, the cost per pixel, and therefore the cost of the display, may be lower than alternative devices supporting larger sub-display sizes. In addition, the present invention generates numerous unexpected benefits from the resultant processor network and its ability to perform local control on the array.

Display and/or sense arrays according to the present invention provide “infra-extensibility”, as in which both processing power and communication throughput extend automatically in response to display size increases. This novel form of extensibility is made possible as each subarray element contains its own processing and local communication so that as display size increases, the amount of processing power increases accordingly. In addition, the communication structure is configured so that information can be received as desired through any subarray display circuits located along the periphery of the display, or any desired plurality of subarray display circuits located along the periphery of the display, or even through all of the subarray display circuits which are located about the periphery of the display—without the need to modify these circuits in any way.

### 2. Infra-extensible Array Packaging

Subarray display circuits according to the invention can be interconnected into one dimensional (1D) and more preferably two dimensional (2D) arrays to implement a display and/or sensing matrix. It should also be appreciated that the interconnections supported by each subarray display circuit can be extended into three dimensions (3D) by adding two additional interconnections to each of the subarray display circuits and similarly extending the programming to operate in three dimensions. However, for the sake of simplicity of description, the following sections describe the invention by way of example within a two dimensional array of outputs and/or sensors.

It should be appreciated that the subarray display circuits of the invention can be interconnected into a display and/or sensing matrix according to any desired fabrication methods without departing from the teachings of the present invention. The following are provided by way of example and not limitation regarding a 2D matrix. (a) Multiple subarray display circuits may be fabricated on a substrate which forms an entire display and/or sensing matrix, or a portion of a larger display and/or sensing matrix. (b) Multiple subarray display circuits may be fabricated into rows, columns, or combinations thereof, which are interconnected into a display and/or sensing matrix. (c) Subarray display circuits, or clusters thereof, can be separately fabricated and then interconnected to one another or interconnected directly or indirectly upon any desired structural contrivance. In one example the subarray display circuits are fabricated on a rigid substrate (e.g., printed circuit material) and then interconnected to a flexible backing which provides physical retention and connectivity of power and communication signals. (d) One or more processors can be coupled to the outputs and/or inputs which are retained on the same structure (e.g., backside, periphery, stack, and so forth), or coupled to a separate structure containing the outputs and/or inputs.

If the area of a display element subarray is at least as large as its associated control circuitry, then it is possible to mount the LED subarray and its associated control circuitry onto the same base (substrate), such as on opposite sides of a common substrate (e.g., printed circuit board, or any desired structure configured for mounting and conductively interconnecting electronic circuits). If all the components are chosen to have a low profile, then the entire assembly can be fabricated into a very thin apparatus, such as one that is on the order of two to three millimeters. Furthermore, if no rigid components are bridging the boundaries between the sub-displays, the assembly can bend or flexed along those boundaries, thus increasing practical applicability and increasing display survivability.

In has been appreciated in the present invention that producing large displays from a single continuous substrate may not be feasible or the most economical. Thereby the present invention allows joining multiple display subarrays together, or first combining multiple display subarrays together into strips or larger sections, that are then joined together to form the complete display. If a flexible substrate is selected, then the strip displays can be suitably producing using a low-cost roll-to-roll fabrication method.

In addition, the display and/or sensor array of the present invention can be fabricated in a “hybrid” flexible electronics format which utilizes rigid components mounted to a flexible interconnective material. This form of embodiment recognizes that rigid components may have desirable characteristics that are not available from flexible components. A good example is silicon integrated circuitry, which has higher density, higher speed, and operates at a lower power than is currently possible with flexible alternatives such as printed organic electronics. Although a very thin silicon die can be slightly flexed, this approach prefers to consider the subarray display circuit substrate to be rigid, and the flexibility to be gained in response to connection to the interconnecting mesh.

It will be appreciated therefore that the present invention may be fabricated or manufactured in a number of different ways and combinations thereof without departing from the teachings of the present invention.

### 3. Infra-Extensible Display Control

One of the objects of the present invention is providing a means for controlling an optical display or backlight, such as one utilizing LEDs or other elements configured for optical output. In at least one embodiment, control of the optical elements is performed at the subarray display circuit level as each subarray display circuit contains a computer and memory (e.g., single-chip microprocessor, microcontroller, signal processor), or any circuit or circuits configured for performing input and output in response to program execution. It should be appreciated that microcontrollers usually include memory, interrupts and I/O control in a low cost single package device. However, the teachings of the present invention are not limited to the use of any particular type of processing device. Displays which are assembled from a matrix (array) of subarray display circuits as described herein combine localized computation with display output functionality.

FIG. 1A through 1B depict a first and second side of a substrate 12 for an example embodiment 10 of an active element (LED) subarray module referred to herein as a subarray display circuit, although it may fulfill display and/or sensor functions. An array of display elements 14 (e.g., LEDs) are shown in FIG. 1A, which by way of example are depicted comprising a 4×4 array of LED display elements which can each comprise single or multiple color display elements having one or more internal elements. Within each LED package 14, the figure depicts by way of example three small squares which represent the die of three separate light emitting diode elements within the package. Although it should be appreciated that the elements may comprise single color elements, bi-color elements, or any desired configuration of optical elements without departing from the teachings of the present invention. Control circuitry for the subarray is shown in FIG. 1B with a microcontroller 16 which is coupled to the display elements shown on the reverse side in FIG. 1A.

One aspect of the infra-extensibility of the present invention is derived from the interconnection of neighboring subarray display circuit processors. These communication links can serve numerous purposes, including programming the microcontrollers, receiving and distributing information on images to be displayed, passing sensor information between neighbors and to the array periphery, exchanging messages for synchronization and computation, performing local control of display and/or sensing aspects and so forth. In addition to display and/or sense functions, the mesh (e.g., 2D) of interconnected processors (e.g., microcontrollers) can function as a general purpose MIMD (multiple-instruction multiple-data) parallel computer. Each subarray processor directly communicates with its neighbors, without the necessity of first communicating back to a central controller which then communicates with other display elements. By way of example and not limitation, embodiments are described for a single-wire implementation and a two wire implementation.

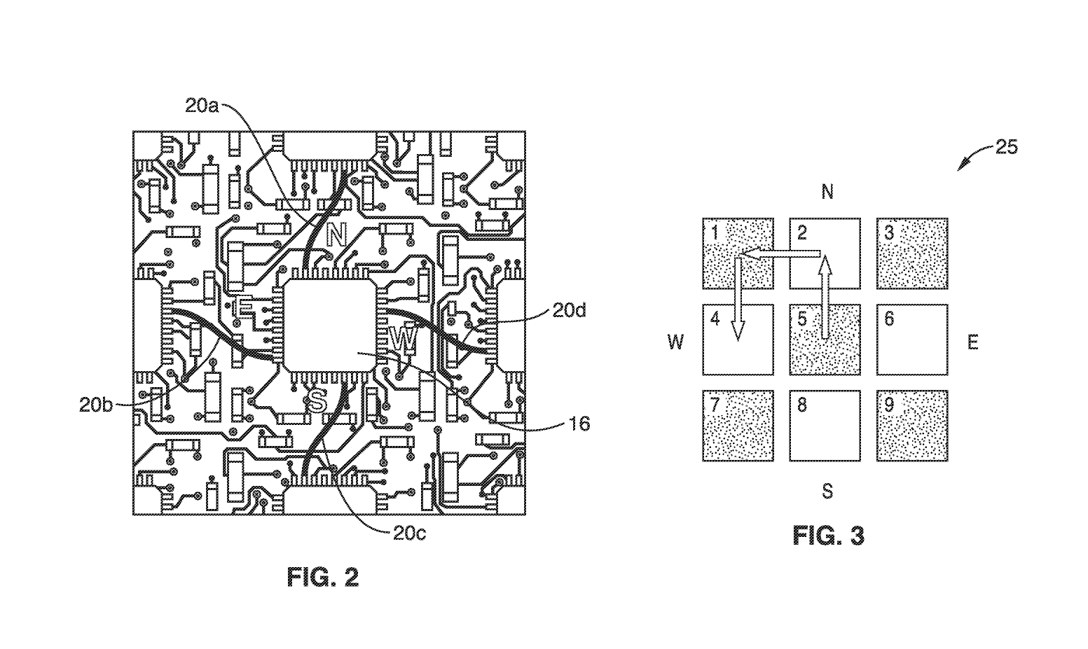

FIG. 2 illustrates a portion of a circuit having interconnected subarray display circuits, of which a processor 16 is seen in the center of one subarray display circuit and is surrounded by additional processors 16 (portions of which are seen about the edges of the image) of neighboring subarray display circuits. In a preferred embodiment, each central processor is shown with communication connections to processors within the four adjacent subarray display circuits, specifically one in each direction referred to herein as north, east, south and west. In a preferred embodiment, each subarray processor in the display array is connected with four neighbors, such as by connection 20a, 20b, 20c and 20d. It will be appreciated that in the figure a pseudo-connection is shown as traces may be buried on inner layers. In addition, the connection may comprise any desired interfacing and intermediate buffering. However, in preferred embodiments, the interfacing comprises a single wire connection or a two wire connection. It will be appreciated that the ordering of the communications paths can be as desired and need not follow the one given above by way of example.

Although it substantially increases I/O requirements and program overhead, embodiments of the present invention can be configured to support communication paths with diagonal neighbors. However, it should be appreciated that in the four neighbor connection scheme, information is passed with minimal delay to diagonal neighbors through the North, East, South and West neighbors. In addition, it has been mentioned that additional communication paths can be connected to other 2D array planes to form a 3D array according to the invention.

FIG. 3 depicts by way of example embodiment 25, a plurality of interconnected subarray display circuits (shown as blocks 1-9) within at least a portion of a display and/or sense array.

In a single wire implementation, a single wire is coupled between ports on adjacent subarray processors. To prevent “collisions”, in which processors simultaneously attempt to transmit into one another by driving their respective output lines, the present invention adopts a segmented scheme in which alternating processors, such as according to a checkerboard pattern (represented in this figure by shading), are allowed to only initiate communication in select directions. For example, a first group of processors (shaded) is allowed to initiate communication in a north and south direction, and a second group (unshaded) is only allowed to respond in the north-south direction and initiate communication in east and west directions. In addition, it is preferred that a resistor be placed along the single wire path as necessary to prevent any possible damage when I/O pins from adjacent processor are both in an output mode.

A protocol executed in the programming of a single wire embodiment assigns the role of “initiator” to one of the two processors sharing a given interconnection. These assignments make it necessary to pass messages along indirect routes when the direct route is along a wire for which the sender is not the initiator.

The figure depicts an indirect initiator route from subarray display circuit (5), to subarray display circuit (4) going through subarray display circuits (2) and (1).

The initiator-responder designations are preferably initially based on the locations of the processors in the array. Later, by mutual agreement between the processors, these designations can be changed. Utilizing this protocol the messages often follow an indirect path between the source and destination as shown in the figure.

To communicate over a single wire, a protocol was designed that took into consideration that each processor has its own internal clock, the processors can switch the function of a pin between input and output, an un-driven line can be passively pulled high at the input pin, and that an input change can be used to preferably trigger asynchronous interrupt. According to this protocol, it is first necessary for the initiator to get the attention of the responder. By way of example, the initiator can do this by disabling interrupts, sending an initiation pulse, and waiting for a response pulse. The initiation pulse causes the responder to enter an interrupt service routine (ISR) and return a response pulse. At this point both processors have interrupts disabled and are ready to transfer a single byte of data using a simple pulse width modulation scheme. After the byte is transferred, the responder returns from the ISR and the initiator enables interrupts. This sequence is repeated as many times as necessary to transfer a multi-byte message. It will be appreciated that the one-wire protocol above is provided by way of example and not limitation, as any type of single wire protocol can be selected without departing from the teachings of the present invention.

In a two wire implementation, two lines connect to each adjacent processor so that dedicated transmit and receive directions are established, which eliminates the problem with collisions but requires additional processor I/O pins.

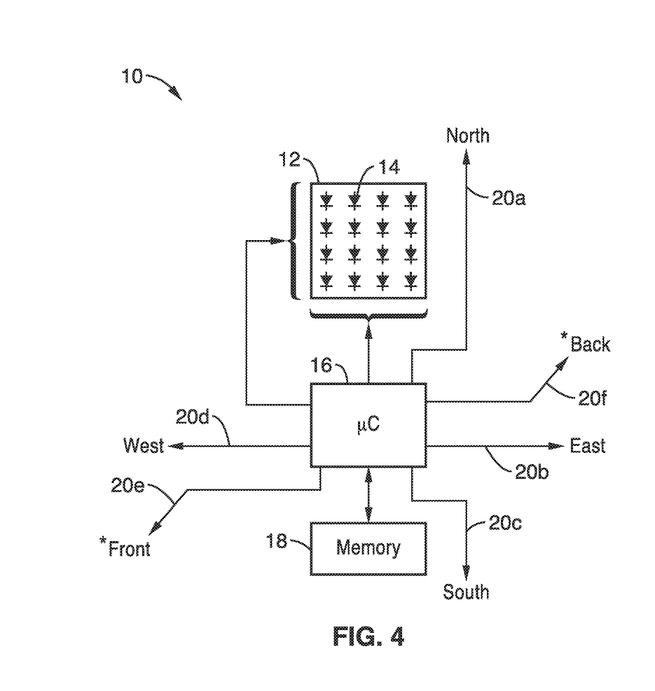

FIG. 4 illustrates an example embodiment 10 of the subarray display circuit, showing array 12 of elements 14 coupled to microcontroller 16 having memory 18. Four interconnections 20a, 20b, 20c, and 20d are depicted for communicating with adjacent neighbors on the north, east, south and west. In addition, optional connections 20e, 20f are shown for increasing the level of communication, such as to processors located on the diagonal, or to other devices not limited to processors, or connected to other array planes in a three dimensional (3D) array.

### 4. Driving Elements Via Multiplexing

The subarray display circuit of the invention can control each of its respective array elements either statically, or alternatively according to any desired form of multiplexing. By way of example and not limitation, the present invention primarily describes using multiplexing to reduce the number of processor I/O pins which are necessary for controlling a desired number of display elements. The perceived brightness of optical elements (LED) within each subarray display circuit is determined in response to microcontroller actions, such as by the rate at which multiplexed LEDs are scanned and the on-time of individual LEDs. The microcontroller turns LEDs on or off by varying the mode or voltage of its I/O pins and either directly controlling the LEDs or sending signals to switching devices for indirectly controlling LED operation. The I/O pins of a microcontroller are typically programmable as input pins, output pins, or set into a high-impedance state. An output pin can be set high (to source current) or low (to sink current). This flexibility enables a number of solutions for driving LEDs.

In driving LEDs statically, a simple solution is attained by connecting each LED to +V and an output pin. The output pin sinks current to turn the LED on. Intensity is controlled by varying the duty cycle (the fraction of time the LED is on during each scan). In designs in which there are a greater number of LEDs than microcontroller I/O pins, a form of LED multiplexing can be utilized.

By way of example, an LED can be simply multiplexed by connecting it between each of two I/O pins. In the first case there is one LED between any pair of I/O pins and any given I/O pin is connected either to anodes or cathodes. So the I/O pins are divided into two sets: those that connect to anodes and those that connect to cathodes. Current flows through a particular LED when the I/O pin at its anode is high and the I/O pin at its cathode is low. If only one cathode I/O pin is low, and the rest are either high or in the high-impedance state (Z), then one or more of the LEDs connecting to that pin can be turned on by driving their anode I/O pins. In considering the case in which the number of anode I/O pins is given by the value Nₐ and the number of cathode I/O pins is given by the value N_{c}, then this configuration is capable of driving up to Nₐ×N_{c} LEDs.

In another configuration two LEDs are disposed between each pair of I/O pins. The second case has the same pairs as the first case, but now the roles of the two sets of I/O pins can be reversed to drive the second set of LEDs. As before, multiple LEDs can be driven at the same time by making more than one anode I/O pin high. So this scheme can drive up to 2×Nₐ×N_{c} LEDs.

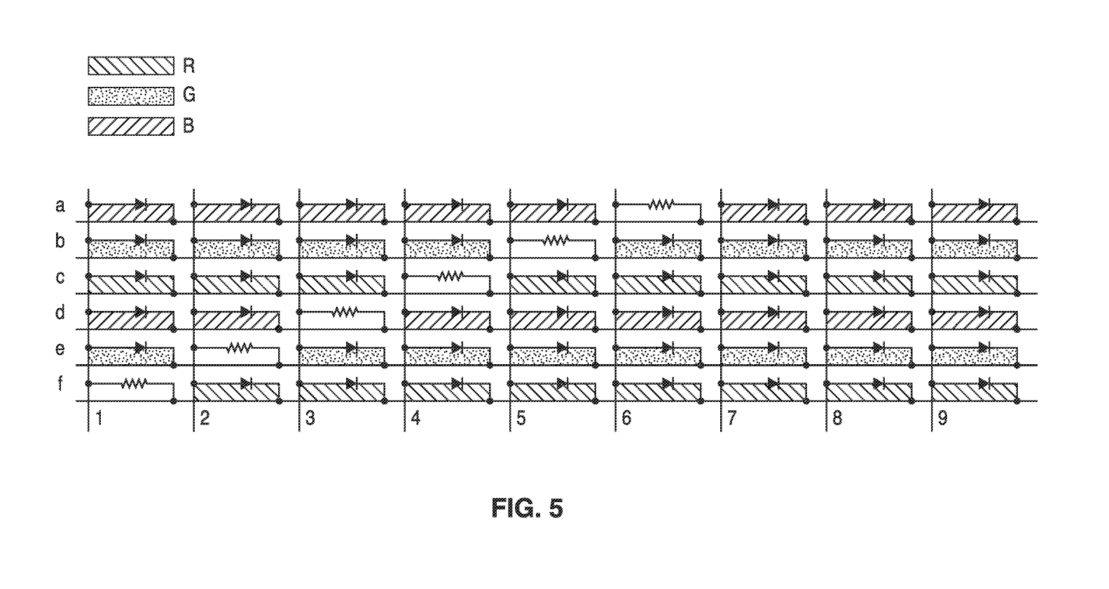

In another case a simple row-column multiplexing scan can be utilized, with a circuit similar to FIG. 5, but without the resistors. It will be appreciated that a simple row and column multiplexing scheme requires m+n pins to drive m×n LEDs.

FIG. 5 illustrates an example of display LED multiplexing of a form sometimes referred to as “Charlieplexing”. The example circuit depicts six (6) rows and nine (9) columns of LEDs and resistors. In this configuration (up to) full connectivity is established between pins in response to connecting only to the nine columns. Therefore, if there are N I/O pins, then there exists N×(N−1) connections and each can support an LED. When one of the pins is low, then any of the LEDs with cathodes at the low pin can be turned on by driving their anode I/O pins high. All the other pins are in the high-impedance (Z) state. It should be appreciated that although there are multiple paths from the high pin(s) to the low pin, only one is direct, the remainder must pass through at least two LEDs. In this scheme, N pins can drive up to N×(N−1) LEDs.

As an example of the Charlieplexing, consider the need to drive a 4×4 array of pixel elements, where each pixel comprises three internal LEDs (red, green and blue), with a total number of 48 LEDs to be controlled. A basic row-column approach would require 14 pins (m+n pins to drive m×n LEDs), while the use of “Charlieplexing” requires only 9 pins (n pins to drive N×(N−1) LEDs). The diagram in FIG. 5 shows how the 48 LEDs are connected to the 9 pins. The “Charlieplexing” in this example allows for driving up to 72 LEDs using only 9 processor I/O pins. In the present embodiment, the “Charlieplexing” allows driving all 48 LEDs from the 9 I/O pins.

In referring to the above figure, it will be appreciated that setting any one of pins 1-6 low allows up to 8 LEDs to be driven by setting a number of the other pins high. If a pin is neither high nor low, it is in the high impedance (Z) state. The microcontroller scans through all six cases so that all the LEDs have a chance to be driven for a certain period of time. This scanning (multiplexing) is performed repeatedly at preferably a sufficiently high scan rate so that the human observer sees only the average intensity of each LED. Individual LED intensities are determined by the fraction of time they are driven. The perceived color of a pixel is determined by the relative intensities of its red, green, and blue components.

It should be noted that the current from 0 to 8 LEDs will pass through each resistor. Sharing in this way minimizes the number of resistors; however, the intensity of an LED becomes dependent on the number of LEDs being driven. This variance can be readily overcome by the LED scanning software which is configured for sufficiently increasing activation time as the number of active LEDs driven through a single resistor increases. Alternatively the current sharing problem can be overcome without changing the average current of each LED, by activating one LED at a time so that the full current can pass through the LED, after which the other LEDs to be activated in that row are separately driven.

### 5. Light Sensing in the Array

Embodiments of the present invention can be configured for sensing across an array of sensing elements spatially disposed on each subarray display circuit and controlled by its associated processor (e.g., microcontroller). The following will consider, by way of example, the use of light sensing, however, it should be appreciated that other sensing can be performed without departing from the teaching of the present invention (e.g., non-visible radiation, pressure, temperature, moisture, biologic sensors, and so forth). In addition, the pixel elements of the display need not be limited to LED lighting elements, but may comprise other forms of electrically responsive display elements. Light sensing elements may alternatively comprise other light sensitive devices, such as photo-sensors that provide sensitivities, response times, or wavelengths which are not available from LEDs. It should be appreciated that the sensing function may be used to sense aspects of the processor or display elements themselves, such as the temperature of the processor or display element, or the light output level of the display elements.

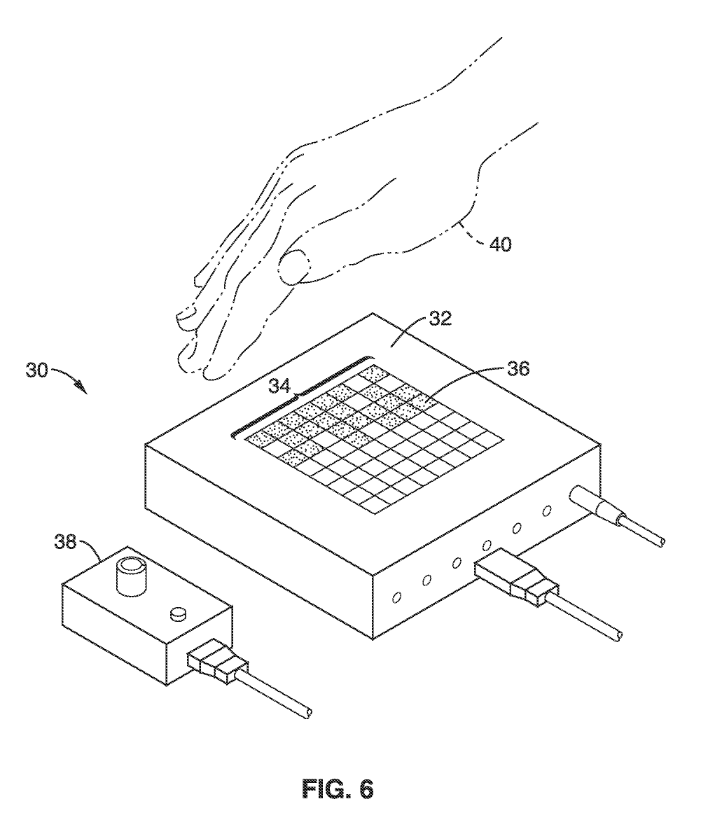

FIG. 6 depicts an embodiment 30 of the present invention configured for light sensing within an 8×8 array of subarray display circuits configured for display and light sensing with 48 LEDs per subarray display circuit. A display housing 32 is shown containing an array 34 of elements 36. A controller 38 is shown which can communicate to the display and which preferably controls synchronization. In this embodiment at least a portion of the LEDs are configured for operating in both output and input modes, or stated another way the LEDs operate in a display mode and a sensing mode. Device 30 can thus sense light received at the device and use this information for both local and remote operations. In this example, the display senses which of its elements are in shadow (e.g., light intensity detected as falling below a desired threshold) as exemplified by shading under hand 40. In response to this shading, LEDs are activated under program control of the local subarray display processor. This localized control can be performed on the same subarray display processor, or messages sent to nearby processors, depending on the desired extent of activity.

System controller 38 can provide a number of system level functions such as monitoring user controls and generating messages to the array of subarray display circuits. It should be appreciated that this controller (an I/O controller) sends commands and data to the subarray display circuits, and can receive message generated by any of the subarray display circuits and communicated through the subarray display circuits back to the controller. By way of example, the system control device is shown with a button and a knob allowing user input for the classic Pong game in response largely to local programming performed across the array of subarray display circuits. However, the inputs have also been utilized during testing of the invention for interacting with cellular automata emulations, controlling the speed at which cells are updated, ensuring that they are synchronized for input and output modes, and for controlling a crude camera. It will be appreciated that the array of processors and the interoperability with the associated output and/or input functionality can be utilized to perform a wide range of functions not limited by the above examples.

It should be appreciated that the LEDs themselves are utilized in this embodiment for sensing the level of received light. In using LEDs as light sensors within an embodiment of the present invention, the entire display becomes a sort of crude camera. In one preferred mechanism for sensing light with an LED, the LED is considered as a capacitor whose discharge rate can be accelerated in response to the amount of light received. In one mode of the present invention, the microcontroller is configured to reverse bias the LED and then removes the bias, allowing the LED to discharge. The discharge rate is measured by recording the time it takes for the LED voltage to appear as a logical low to the microcontroller. It should also be appreciated that sensor elements may be alternatively incorporated into the subarray display circuit without departing from the teachings of the present invention.

In the combination display and light sensing embodiment of FIG. 6, the LEDs are connected to the microcontrollers according to the Charlieplexing scheme. It will be appreciated that the use of Charlieplexing prevents sensing from each of the individual LEDs, because of how the LEDs are interconnected. However, it should also be appreciated that this is not a limitation of the invention, as the LEDs can be controlled directly or connected by any desired means of multiplexing which is more amenable to sensing, whereby each element can be readily used in both a display mode and a sense mode. In the present example the Charlieplexing still provides sufficient sensing capability for the needs of this demonstration, as light intensity measurements are performed on any one of three pairs of pixels within each subarray. This is sufficient for estimating the intensity of the light on a subarray basis. To use the full-resolution of the LED array, a scanning mechanism should be selected which allows individual LEDs to be reverse-biased.

When continuously alternating between sensing ambient light and displaying, it is preferable that the microcontrollers are synchronized so that LEDs are not emitting light when nearby LEDs are sensing light. In FIG. 6 the I/O control box is configured to send messages to the microcontrollers. Each message specifies the mode, whether emitting or sensing, to which the microcontrollers are to be set. The time period between these messages also determines the update rate and is a means by which “snap-shots” can be taken.

It should be appreciated that a number of applications may benefit from the ability to sense ambient conditions at the display, the following being provided by way of example and not of limitation. One use for light-sensing in an LED display is to detect shadows, such as might be cast on a large outdoor display, and to adjust the LED intensities to compensate and improve the appearance of the displayed image. Another use is to detect light from a laser pointer. For instance, green laser pointers are readily detected by red LEDs, and of course other combinations between impinging light color and LED color provide similar detection. The subarray display circuit microcontrollers according to the present invention can determine the location of the “spot” of light from the pointer. Multiple spots, from multiple pointers, can be detected in parallel. This would allow one or more persons to interact with the display and to do so at a distance. To distinguish between pointers, the output (intensity, polarity, wavelength, and their values over time) can be made to differ between pointers.

### 6. Direct and Indirect LED Current Control

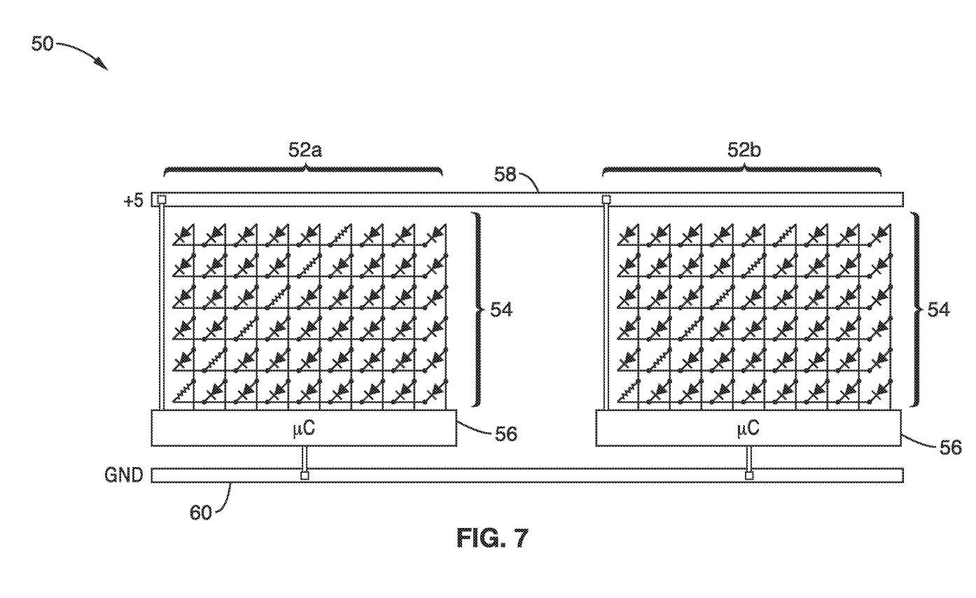

FIG. 7 illustrates an embodiment 50 of a portion of the display showing two LED subarray display circuits 52a, 52b, each having an array of elements 54 which are controlled by their associated microcontroller 56 to which power 58 and ground 60 are connected. In this example, the microcontrollers themselves source and sink current to the LEDs. The voltage difference between the high and low output pins (which in this case will be somewhat less than 5 volts) may be greater than what is needed by an LED. This is why resistors are included in the array. The resistors drop the voltage to what is needed by the LEDs.

In at least one embodiment, the microcontrollers can control LED display currents indirectly, such as to reduce the level of LED current passing through the microcontroller, or overcome limitations on the current-carrying capacity of the microcontroller or its I/O pins. So instead of directly driving the LEDs the current is passed through a separate circuit element(s), such as a power MOSFET or similar switching device, whose operation is controlled by the microcontroller. Another reason for indirect control is to allow the voltage supplied to the LEDs to differ from the voltage supplied to the microcontrollers. Microprocessor power dissipation, for example, can be reduced by operating the microcontroller at a lower operating voltage than the display elements.

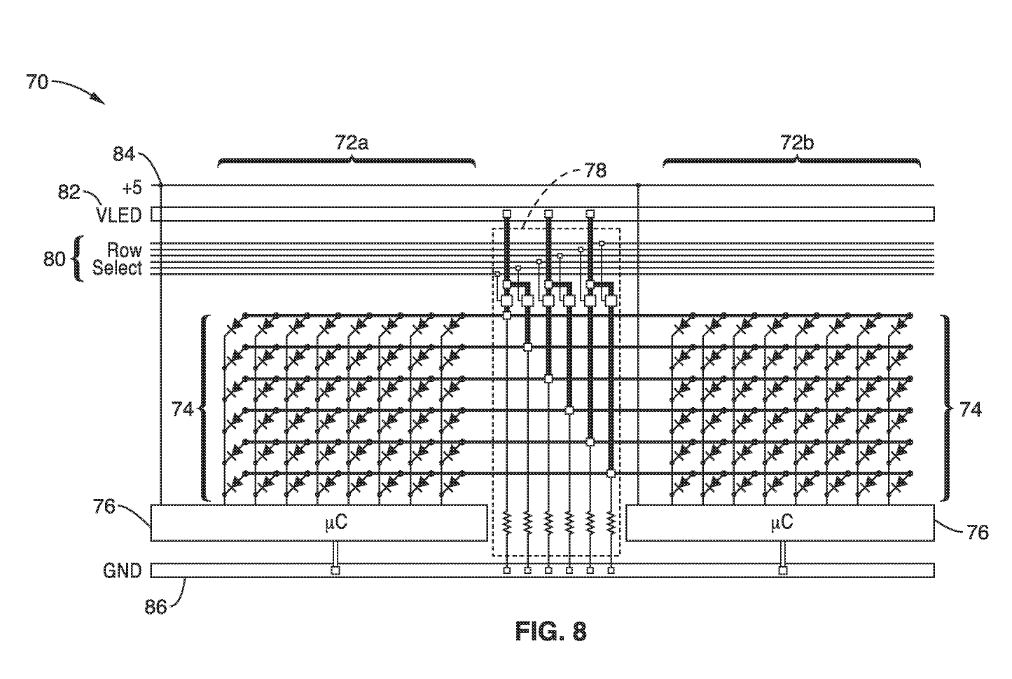

FIG. 8 illustrates an embodiment 70 of a portion of a display showing two subarray display circuits 72a, 72b, each having an array of elements 74 and associated processors 76. In this example the LED array is controlled in response to indirect control of the rows. In this embodiment the microcontrollers are only utilized to sink current with driver circuitry 78 used in combination with row select signals 80 and LED drive voltage 82. It will be noted that the processors are powered from a different power source 84, although a common ground 86 is utilized. It will be appreciated that LED drive voltage, VLED 82, can be adjusted according to the forward voltages of the LEDs, eliminating the need for voltage-dropping resistors and thus increasing efficiency. The source current to each row is supplied through an analog switch. The switches are depicted in this figure as small squares which are turned on and off by row select lines. The row select lines, as well as VLED, can be controlled by the existing processors, or more preferably by another microcontroller. It will be appreciated that numerous forms of drive circuitry are available which may be utilized according to the present invention. For the sake of simplicity, a signal is not depicted for allowing the row controller to synchronize the microcontrollers to the changes in row selection. The approach shown here is particularly well-suited for use with a strip, a half-strip, or a horizontal segment of a display.

The embodiment shown in FIG. 8 can be configured for performing light sensing as previously described. In this mode, the switches are open and the rows are pulled low by the resistors shown in the bottom center of the figure. A column of LEDs is reverse biased by setting the microcontroller output pin to high. Then the pin is re-programmed to be an input and microcontroller measures the time required for the LED voltage to appear as a logical low, and can be performed for all the columns at the same time or at different times.

### 7. LCD Backlight Unit (BLU) with Light-Sensing Capability

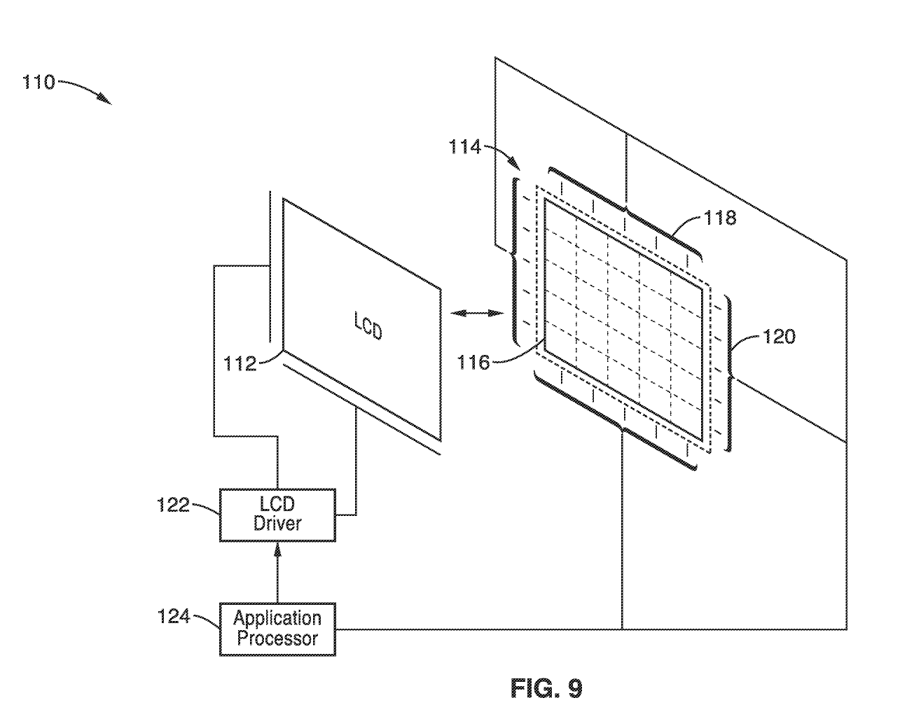

FIG. 9 illustrates an example embodiment 110 of an interconnected array of subarray displays circuits which are combined into a backlight for another display 112, depicted as a liquid crystal display (LCD). A plurality of subarray display circuits 116 are shown interconnected into an array 114 which receives image information through processors along any, or all, of the peripheral portions 118 of the array of subarray display circuits as desired. The figure depicts little dashes centered on each subarray display circuit represent where a serial connection may be made. It will be appreciated that 118 does not depict row and column driving, but communication paths to the processors of the subarray display circuits, each of which is communicated to with serial data. An application processor 124 is shown, by way of example only, for controlling LCD 112 through an LCD driver circuit, and for supplying information to, and receiving information from, array 114 of the present invention.

As a light emitter, the array of subarray display circuits can display a pattern of brightness and color so as to achieve a high-dynamic range effect. As a light sensor, the array can sample the light field passing through the LCD. This can be used to create a flat light-field camera or to detect light from a laser pointer, as well as numerous other optical applications. The two modes can be combined according to embodiments of the present invention to create, for example, optical I/O devices for interacting with computers.

When in a light emitting mode, the LED array serves as the backlight unit for the LCD. If the LED array emits white light, a color display can be produced by an LCD with sub-pixels having colored filters. The output from the LED can be non-uniform as desired for improved contrast. If the LED array emits at different colors, such as red, green, and blue, then the contrast can be improved further and colors can be more saturated. The LEDs can make areas of the array much brighter or darker than other areas, significantly increasing the contrast and dynamic range of the display. Another arrangement is possible for monochrome LCDs. In this case there are no color filters, so there are no filter losses and the pixels are filled entirely by the current color, which improves resolution and brightness. For color, the LCD must be fast enough to cycle through the patterns for red, green, and blue at a rate that is too fast for the eye to see. The LEDs provide the colored light, creating either a uniform or non-uniform intensity field, which is synchronized with the LCD.

When in light sensing mode, the LCD can be used to select what can be “seen” by the LEDs by opening/closing LCD pixels. Color selectivity can come from the LCD or the LEDs. This is because LCDs may have sub-pixels with red, green, and blue filters, and because the LEDs are wavelength sensitive. If each LED can “see” multiple LCD pixels, the LCD pixel open/closed pattern can be used to admit light from different directions. The information from different directions can be combined to make a synthetic aperture camera. This is what is done in “coded aperture astronomy” where a mask, a pattern of opaque and transparent areas, is used to encode the incoming light field and computational methods are used to construct a 3D image. The LCD, in this case, is an active mask whose patterns can be changed to achieve various effects, such as changing the focal length.

In the case of receiving incoming light from a laser pointer, the LEDs in combination with LCD control allows detecting the direction from which the light is being received and perhaps its point of origin. For example direction can be determined in one axis by alternatively shuttering to the right and left of a light sensor and determining which direction impinges or is blocked from the sensor. The technique can be extended to determine any impinging light direction relative to the display plane.

Another use for light detection is to recognize detected ambient light in generating the displayed output image so that it appears the scene is being illuminated by light originating in the real world. Also, detecting shadows or reflections can be utilized to determine where objects may be located that are on, or in the vicinity of, the display surface.

### 8. Array Control Programming

Element arrays are controlled by each subarray display circuit in response to programming executing on each respective processor. Subarray display circuit processors can interact with one another for distributing information, for performing collective processing tasks, and so forth. A system level processor can be coupled to an array of the subarray display circuit processors for sending image information and collecting information back from the array of subarray display circuits.

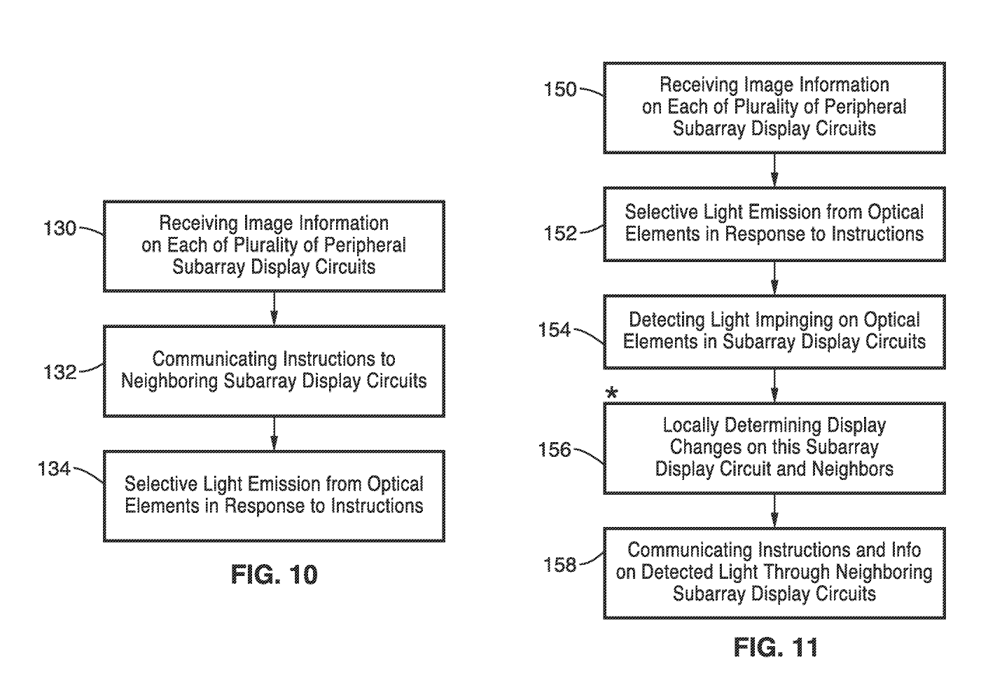

FIG. 10 illustrates an example of programming performed on the subarray display circuits according to an embodiment for controlling output elements. Image information is received as per block 130 by the image array, communicated to neighboring subarray display circuits as in block 132 and the output from the optical elements is selectively controlled in block 134.

FIG. 11 illustrates a similar process for controlling an array of output and inputs. Image information is received as per block 150 by the image array. In one phase of operation, such as from a prior command, output from the optical elements is selectively controlled in block 152. In another phase, detection of sensor input occurs, such as light intensity on the LEDs, in block 154. Optionally, the programming can locally determine display changes for the associated display elements shown in block 156. Finally, communication is performed in block 158 of both the instructions from neighboring subarray display circuits or from an external control system passed through neighboring subarray display circuits, and communication of detected light levels to neighboring processors and optionally through them to an external control system.

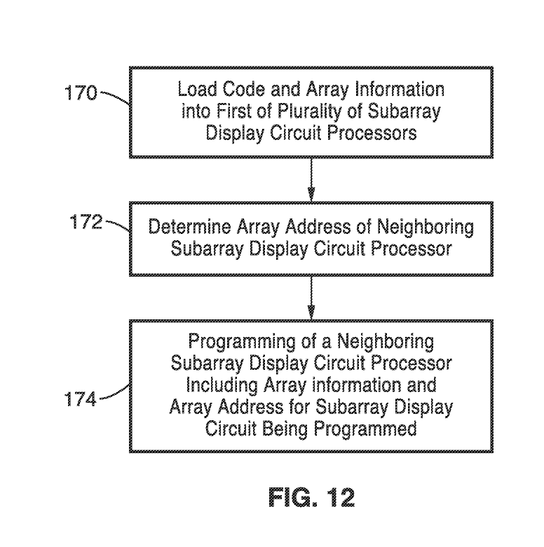

FIG. 12 illustrates an example of initially programming an array of subarray display circuits which have been connected into an array prior to programming. All processors preferably contain non-volatile memory and are placed in the array in an unprogrammed state without address information. Prior to programming they are set in an initial state ready to accept programming.

Programming and data (e.g., initial address, dimensions of the array, operating mode, and so forth) is loaded into a processor of a first subarray display circuit as in block 170, such as from a system level processor. An address is determined for a subsequent subarray display circuits as block 172, whereafter the first unit programs the second unit in block 174 with its coding, array information and its array address. Code copying continues until each subarray display circuit is loaded with the programming, address information and information about the array.

In one implementation, array location is determined in response to the order in which the microcontrollers of the respective subarray display circuits receive their code, which is preferably in a serpentine pattern. By way of example, the path can start at one corner, traverse down the row, drop down to the next row, go up that row, drop down again (now on third row), and so forth. The code contains the row length, and a count is incremented and communicated to each successive microcontroller as part of the loading process. Once a microcontroller is loaded it knows its number (the count) and the array width, so it can compute its X and Y locations. In other embodiments each row (or column) can be programmed separately, so a row number is supplied in addition to the count during programming. One of ordinary skill in the art will recognize that numerous variations of the above can be implemented for determining an array position address without departing from the teachings of the present invention.

According to one implementation of the programming method, each subarray display circuit has a single six-pin port for in-system programming (ISP) of the microcontrollers. The hardware allows all the microcontrollers in the different subarray display circuits to be programmed through this port without the use of long wires. Toward this objective microcontrollers can be linked together to form an ISP chain and code written so that each microcontroller copies its program into its successor. Each link in the chain uses four wires: one for data from the master to the slave, one for data from the slave to the master, one for the shift clock, and one for RESET. Each processor is held in the RESET condition while its code is being loaded. After the initial program load, the RESET condition is removed and the processor runs with the loaded code and data. At this point there can be additional ways to download code and data using inter-processor communication (IPC).

### 9. Application Examples

Interaction with System Level Software.

It will be appreciated that the array of interconnected subarray display circuits according to the invention will often interact with system software which is not executing on the processors of the subarray display circuits. For example, system software can supervise loading programs and data into the subarray display circuits, provide synchronization, supply an image stream for being output, and process information received from the array of subarray display circuits. Local control by the subarray display circuits does not in any way abridge or limit the ability for external communication and control.

Application software can be associated with system programming for performing any desired conventional display and/or sense applications. The application software can also perform applications, such as emulating cellular automata, rendering graphics primitives, playing games (e.g., PONG), implementing a camera, and functioning as a self-organizing neural map as a specific form of cellular neural network, and numerous additional operations and combinations thereof in response to using the distributed processing provided according to the present invention.

Applications Supported with Local Processing.

The present invention provides the ability to perform local operations on the display outputs, and/or the sensed inputs. Typical display configurations rely wholly on external control and coordination, while the subarray display circuits described herein can act locally in response to information obtained locally from local sensors or from information received from nearby subarray display circuits. This local processing and interprocessor communication can be utilized to support a number of beneficial applications according to the present invention. The following is a partial list provided by way of example and not limitation.

Local Operation in Processor Programming.

It will be appreciated that the processors can use intercommunication for initial programming into subarray display circuits which are unprogrammed, or alternatively to reload a processor whose code has become corrupted.

Receiving Commands.

In addition, data may be loaded to the array of interconnected subarray display circuits in a neighbor-to-neighbor communication. For example, new calibration data or operational mode information can be downloaded. The present invention as described allows communicating information from an external device, such as information for displaying a new image. Information may also be uploaded from local sensors, such as one or more temperature sensors located on each subarray display circuit, from optical sensors, current sensors, acoustic transducers (e.g., microphones), and so forth. This information can be utilized by the local subarray display circuits in which it is registered, such as for controlling the output display, and/or communicated to processors on nearby subarray display circuits for their operation, or communicated through processors of other subarray display circuits and out to a system computer.

Sending Commands.

External commands received at an array of subarray display circuits may be broadcast to all the processors through this neighbor-to-neighbor communication interconnection. By way of example, the message can be replicated and forwarding to other processors. Fixed messages can be passed, such as including mode change messages (e.g., from emitting to sensing). In non-fixed messaging, prior to being forwarded a collected status information can be included to update a message, such as in relation to a voting scheme, or byte chain, in which each processor through which the message travels includes local information regarding its own operations or sensing. A local processor may detect some condition and decide on its own to send a communication to alert nearby processors, and/or the external system. For example, an operating anomaly may be detected. In response to this, nearby processors may take action, such as reprogramming the processor generating the alert, or modifying how the display is output. Messages can be utilized as a manner of clocking with speed controlled by the user to adjust the rate at which processing is performed within the display. For example assuring that display changes are performed at a “human-friendly” rate, that is sufficiently slow enough for a human user to see or take note of them.

Emulating Cellular Automata.

Each processor of every subarray display circuit can emulate a subarray within an array of cellular automata. Accordingly, each cell is configured with a state, which is changed, such as in response to a pseudo-clock tick, based on the states of some set of its neighbors and possibly its own state. This change preferably has two phases; a first phase in which all the cells acquire the states of their neighbors, and a second phase in which all the cells change their states based on what they acquired in the first phase (e.g., according to a rule, or set of rules, that may or may not be the same for all the cells). The processors need to communicate during the first phase, and possibly to propagate a message that implements the pseudo-clock tick. The cell state can also be displayed using the LEDs, either with a one-to-one relationship, or more preferably by displaying a “window” into the cell array.

Control of Animations.

As previously mentioned, one embodiment of the invention implemented a “Pong” game (e.g., four paddles, walls, and a ball) which made use of local processing. The location of the ball, for example, was communicated via messages sent between the subarray display circuits. Paddles were move in response to messages received from an external I/O device. Animations have also been generated that are similar to a stadium card stunt, in which processors display patterns that are selected and coordinated to create various images, and so sequenced to produce the animation.

Rendering and/or Decompressing Images.

Abstract display information can be processed within the array of subarray display circuits in preparation for each subarray display circuit generating an appropriate output. For example, according to at least one implementation, vectors received by the array of subarray display circuits can be rendered. Areas defined by points or lines can be filled in, such as areas (e.g., triangles) defined by lines or points, and filled with colors as desired in performing graphics primitives as may be normally executed by a dedicated display processor. The processors figure out which of themselves has to render all or a part of the primitive and send messages accordingly. This can be viewed as a form of cooperative image compression. The processors can collectively decompress a compressed image, which reduces image download time. The processors can buffer data to smooth out processing overhead changes. It will be appreciated that a wide range of distributed processing can be performed locally, or in cooperation with external devices.

Finding and Tracking Inputs.

It was described in a prior section that the distributed processing of the interconnected subarray display circuit of the infra-extensible array of the invention can find and track a light input, such as a laser pointer spot and drawing cursors. This ability can be performed by a display device that need not be coupled to an LCD display as previously described. It will be appreciated that various inputs can be detected and tracked, according to the type of sensing being performed, which are then acted on locally and whose effect may show up in the display output from a subarray display circuit.

Processing Light Field Data.

An LCD, or other aperture device, can be utilized as a mask for “coded aperture imaging” (forming a 3D camera without a lens), and as an active mask for changing focal length or other attributes.

Simulating Neural Nets.

The infra-extensible array according to the invention can be implemented to provide cellular neural nets (CNNs), such as so-called self-organizing map (SOM). In one implementation a 2D array of “neurons” is simulated by the subarray display circuits, for example allowing each processor to represent a single neuron or group of neurons. Neuron weight mapping then changes in response to new input data, such as received in response to a message. The change is applied to a point in the map that is determined by comparing the new data with everything already in the map. By way of example a pair of binary tree patterns can be utilized (e.g., out-going and in-coming) to direct the data (route messages) from the data insertion point through the map to find this point and communicate the result. The neurons influence each other, so the change propagates through some part of the map. This influence propagation is particularly well suited for simulation using messages between neighboring interconnected processors according to the invention. If each neuron, for example, has a vector of three weights, then the weights can be utilized to compute red, green, and blue intensities of the display output from the subarray display circuit. By associating each neuron with a pixel, a map can be observed of the distribution of neural weights while it forms. Alternatively, the weights can be used, or converted thereto, for modifying a display output or function in response to neural-like processing.

Data Clustering.

In data clustering, an array is loaded with data and local exchanges performed to do a sort, such as a 2D sort. Depending on the conditions for executing an exchange (e.g., in which two data elements swap places), the data can be expected to form clusters according to shared properties. One application for this is locating sound sources based on streams of acoustic data from an array of acoustic transducers (e.g., microphones). This is particularly well suited for the present invention, in which each subarray display circuit is adapted for receiving information from one or more local acoustic transducers and interacting using local processors to process and thus cluster the data. By way of example, the display can change based on registering the direction of sound or its character. For instance with the microphones embedded within a display, a symbol, such as a pair of eyes could be displayed which appear to “look” in the direction of and optionally focus at the proper distance of a dominant sound source. The present invention provides a neighbor-to-neighbor neural behavior which is a more “brain-like” way to process data and which can provide additional information within an increasingly robust system when compared to traditional approaches.

Display/Sensor Mapped MIMD.

The infra-extensible output and/or input array control apparatus according to the present invention provides functionality which extends beyond that of typical display or sensor arrays, allowing forms of processing following multiple instruction multiple data, neural net, or similar paradigms. Outputs from each processor maps to part of a display (or other output) while the local processor is free to update its output without dependence on external processing of image data. The image data is generated by the computations performed by the processors. Similarly, sensor inputs can be mapped across the processors, or the interaction between sensor inputs and outputs can be processed cooperatively across the neighboring processor landscape.

### 10. Summary of Aspects of Invention

This section summarizes, by way of example and not limitation, a number of implementations, modes and features described herein for the present invention.

The present invention provides methods and apparatus for controlling an array of outputs and inputs within a plurality of interconnected and interoperable subarray display circuits having at least one local processor device. Inventive teachings can be applied in a variety of apparatus and applications, including displays, backlighting, other output arrays, various sensor input arrays and combinations thereof. As can be seen, therefore, the present invention includes the following inventive embodiments among others:

1. An apparatus for controlling light emission in an array of optical elements, comprising: a plurality of optical elements disposed on a subarray display circuit; a plurality of said subarray display circuits interconnected into said apparatus to communicate with one another and configured for displaying a light emissive optical output as text and/or graphics; a computer processor and associated memory disposed on each subarray display circuit and coupled to said plurality of optical elements thereon; a plurality of communication channels on said computer processor in which one communication channel is configured for communication with each neighboring subarray display circuit; programming executable on said computer processor for, receiving light emission instructions on each of a plurality of said subarray display circuits located on the periphery of said apparatus, communicating light emission instructions through said plurality of communications channels between neighboring subarray display circuits, and emitting light from said optical elements of each said subarray display circuit in response to said light emission instructions, and wherein said apparatus is infra-extensible in that the number of processors for performing said programming, and the number of communication channels available through which said light emission instruction can be received, increases automatically in response to increasing the number of subarray display circuits within said apparatus.

2. An apparatus as recited in embodiment 1, wherein said plurality of optical elements are disposed on a first substrate side of said subarray display circuit, and said computer processor is disposed on a second substrate side of said subarray display circuit.

3. An apparatus as recited in embodiment 1, wherein said optical elements are coupled to, and directly driven, by said computer processor in a multiplexed or non-multiplexed configuration.

4. An apparatus as recited in embodiment 1: wherein said optical elements are indirectly controlled by said computer processor in response to at least a portion of said optical elements being coupled to power switching devices and emission from the optical elements controlled in a multiplexed or non-multiplexed configuration; and wherein said computer processor controls the state of multiple switching elements for controlling source and/or sink current to individual optical elements, or groups of optical elements including row groups and/or column groups.

5. An apparatus as recited in embodiment 1, wherein said communication channels each comprise a one-wire or two-wire communication connection between input/output ports of computer processors disposed on neighboring subarray display circuits.

6. An apparatus as recited in embodiment 1, further comprising programming executable on said computer processor for storing optical calibration information, for said optical elements, in a memory associated with said computer processor of each said subarray display circuit.

7. An apparatus as recited in embodiment 1, wherein each said optical element comprises at least one optically emissive element within a common housing.

8. An apparatus as recited in embodiment 1, wherein at least a portion of said optical elements disposed on said subarray display circuit are configured for selectively registering light intensity or light emission.

9. An apparatus as recited in embodiment 1:

wherein said plurality of optical elements comprise light emitting diodes (LEDs); and

wherein at least a portion of said LEDs on said subarray display circuit are configured for selectively registering light intensity or generating light emission.

10. An apparatus as recited in embodiment 1, further comprising programming for sensing light received on at least a portion of said optical elements.

11. An apparatus as recited in embodiment 1, further comprising programming for communicating information about the light received to computers in neighboring subarray display circuits.

12. An apparatus for controlling light emission and light sensing in an array of optical elements, comprising: a plurality of optical elements disposed on a subarray display circuit with each optical element configured for emitting light and for sensing light; a plurality of said subarray display circuits interconnected into said apparatus to communicate with one another and configured for displaying a light emissive optical output as text and/or graphics; a computer processor and associated memory disposed on each subarray display circuit and coupled to said plurality of optical elements thereon; a plurality of communication channels on said computer processor in which one communication channel is configured for communication with each neighboring subarray display circuit; programming executable on said computer processor for, receiving light emission instructions on each of a plurality of said subarray display circuits located on the periphery of said apparatus, emitting light from said optical elements of each said subarray display circuit within said apparatus in response to said light emission instructions, detecting light impinging on said optical elements of said subarray display circuits within said apparatus; communicating light emission instructions and information about detected light through said plurality of communications channels between neighboring subarray display circuits; and wherein said apparatus is infra-extensible in that the number of processors for performing said programming, and the number of communication channels available through which said light emission instructions can be received, increases automatically in response to increasing the number of subarray display circuits within said apparatus.

13. An apparatus as recited in embodiment 12: wherein said plurality of optical elements comprise light emitting diodes; and wherein at least a portion of said light emitting diodes are disposed on said subarray display circuit for selectively registering light intensity or generating light emission.

14. An apparatus as recited in embodiment 12, wherein each said optical element comprises at least one optically emissive element within a common housing.

15. An apparatus as recited in embodiment 12, wherein said optical elements are coupled to, and directly driven, by said computer processor in a multiplexed or non-multiplexed configuration.

16. An apparatus as recited in embodiment 12: wherein said optical elements are indirectly controlled by said computer processor in response to at least a portion of said optical elements being coupled to power switching devices and emission from the optical elements controlled in a multiplexed or non-multiplexed configuration; and wherein said computer processor controls the state of multiple switching elements for controlling source and/or sink current to individual optical elements, or groups of optical elements including row groups and/or column groups.

17. An apparatus for controlling light emission in an array of optical elements, comprising: a plurality of optical elements disposed on a subarray display circuit with each optical element configured for emitting light and for sensing light; a plurality of said subarray display circuits, interconnected for communicating with adjacent neighbors, and combined into a combination imager and selective backlight; a selective opacity display configured for displaying an optical output as text and/or graphics, and coupled to said combination imager and selective backlight; wherein said selective opacity display has at least one display state in which light is transmitted through said display to, and/or from, said combination imager and selective backlight; a computer processor disposed on each subarray display circuit and coupled to said plurality of optical elements; a plurality of communication channels on said computer processor in which one communication channel is configured for communication with each of the neighboring subarray display circuits; programming executable on said computer processor for, receiving light emission instructions on each of a plurality of said subarray display circuits on the periphery of said combination imager and selective backlight, emitting light from said optical elements of each said subarray display circuit within said combination imager and selective backlight in response to said light emission instructions, detecting light traversing said selective opacity display and impinging on said optical elements of said subarray display circuits within said combination imager and selective backlight; communicating light emission instructions and information about detected light through said plurality of communications channels between neighboring subarray display circuits within said combination imager and selective backlight.

18. An apparatus as recited in embodiment 17, wherein said plurality of optical elements comprise light emitting diodes; wherein at least a portion of said light emitting diodes are disposed on said subarray display circuit for selectively registering light intensity or light emission.

19. An apparatus as recited in embodiment 17, wherein said selective opacity display comprises a liquid crystal device (LCD).

20. An apparatus as recited in embodiment 17, wherein said apparatus comprises an infra-extensible combination imager and selective backlight in which the number of processors for performing said programming and the number of communication channels available through which said light emission instruction can be received, increases automatically in response to increasing the number of subarray display circuits within said combination imager and selective backlight.

Embodiments of the present invention are described with reference to flowchart illustrations of methods and systems according to the invention. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation various microcontrollers and microprocessors, signal processing devices, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for controlling light emission in an array of optical elements, comprising:
a plurality of optical elements disposed on a subarray display circuit;
a plurality of said subarray display circuits interconnected into said apparatus to communicate with one another and configured for displaying a light emissive optical output as text and/or graphics;
a computer processor and associated memory disposed on each subarray display circuit and coupled to said plurality of optical elements thereon;
a plurality of communication channels on said computer processor in which one communication channel is configured for communication with each neighboring subarray display circuit;
programming executable on said computer processor for,
receiving light emission instructions on each of a plurality of said subarray display circuits located on the periphery of said apparatus,
communicating light emission instructions through said plurality of communications channels between neighboring subarray display circuits, and
emitting light from said optical elements of each said subarray display circuit in response to said light emission instructions, and
wherein said apparatus is infra-extensible in that the number of processors for performing said programming, and the number of communication channels available through which said light emission instruction can be received, increases automatically in response to increasing the number of subarray display circuits within said apparatus.

2. An apparatus as recited in claim 1, wherein said plurality of optical elements are disposed on a first substrate side of said subarray display circuit, and said computer processor is disposed on a second substrate side of said subarray display circuit.

3. An apparatus as recited in claim 1, wherein said optical elements are coupled to, and directly driven by, said computer processor in a multiplexed or non-multiplexed configuration.

4. An apparatus as recited in claim 1:
wherein said optical elements are indirectly controlled in a multiplexed or non-multiplexed configuration using current switching devices whose operation is controlled by said computer processor; and
wherein said computer processor controls the state of multiple switching elements for controlling source and/or sink current to individual optical elements, or groups of optical elements including row groups and/or column groups.

5. An apparatus as recited in claim 1, wherein said communication channels each comprise a one-wire or two-wire communication connection between input/output ports of computer processors disposed on neighboring subarray display circuits.

6. An apparatus as recited in claim 1, further comprising programming executable on said computer processor for storing optical calibration information, for said optical elements, in a memory associated with said computer processor of each said subarray display circuit.

7. An apparatus as recited in claim 1, wherein each said optical element comprises at least one optically emissive element within a common housing.

8. An apparatus as recited in claim 1, wherein at least a portion of said optical elements disposed on said subarray display circuit are configured for selectively registering light intensity or light emission.

9. An apparatus as recited in claim 1:
wherein said plurality of optical elements comprise light emitting diodes (LEDs); and
wherein at least a portion of said LEDs on said subarray display circuit are configured for selectively registering light intensity or generating light emission.

10. An apparatus as recited in claim 1, further comprising programming for sensing light received on at least a portion of said optical elements.

11. An apparatus as recited in claim 1, further comprising programming for communicating information about the light received to computers in neighboring subarray display circuits.

12. An apparatus for controlling light emission and light sensing in an array of optical elements, comprising:
a plurality of optical elements disposed on a subarray display circuit with each optical element configured for emitting light and for sensing light;
a plurality of said subarray display circuits interconnected into said apparatus to communicate with one another and configured for displaying a light emissive optical output as text and/or graphics;
a computer processor and associated memory disposed on each subarray display circuit and coupled to said plurality of optical elements thereon;
a plurality of communication channels on said computer processor in which one communication channel is configured for communication with each neighboring subarray display circuit;
programming executable on said computer processor for,
receiving light emission instructions on each of a plurality of said subarray display circuits located on the periphery of said apparatus,
emitting light from said optical elements of each said subarray display circuit within said apparatus in response to said light emission instructions,
detecting light impinging on said optical elements of said subarray display circuits within said apparatus;
communicating light emission instructions and information about detected light through said plurality of communications channels between neighboring subarray display circuits; and
wherein said apparatus is infra-extensible in that the number of processors for performing said programming, and the number of communication channels available through which said light emission instructions can be received, increases automatically in response to increasing the number of subarray display circuits within said apparatus.

13. An apparatus as recited in claim 12:
wherein said plurality of optical elements comprise light emitting diodes; and
wherein at least a portion of said light emitting diodes are disposed on said subarray display circuit for selectively registering light intensity or generating light emission.

14. An apparatus as recited in claim 12, wherein each said optical element comprises at least one optically emissive element within a common housing.

15. An apparatus as recited in claim 12, wherein said optical elements are coupled to, and directly driven, by said computer processor in a multiplexed or non-multiplexed configuration.

16. An apparatus as recited in claim 12:
wherein said optical elements are indirectly controlled by said computer processor in response to at least a portion of said optical elements being coupled to power switching devices and emission from the optical elements controlled in a multiplexed or non-multiplexed configuration; and
wherein said computer processor controls the state of multiple switching elements for controlling source and/or sink current to individual optical elements, or groups of optical elements including row groups and/or column groups.

17. An apparatus for controlling light emission in an array of optical elements, comprising:
a plurality of optical elements disposed on a subarray display circuit with each optical element configured for emitting light and for sensing light;
a plurality of said subarray display circuits, interconnected for communicating with adjacent neighbors, and combined into a combination imager and selective backlight;
a selective opacity display configured for displaying an optical output as text and/or graphics, and coupled to said combination imager and selective backlight;
wherein said selective opacity display has at least one display state in which light is transmitted through said display to, and/or from, said combination imager and selective backlight;
a computer processor disposed on each subarray display circuit and coupled to said plurality of optical elements;
a plurality of communication channels on said computer processor in which one communication channel is configured for communication with each of the neighboring subarray display circuits;
programming executable on said computer processor for,
receiving light emission instructions on each of a plurality of said subarray display circuits on the periphery of said combination imager and selective backlight,
emitting light from said optical elements of each said subarray display circuit within said combination imager and selective backlight in response to said light emission instructions,
detecting light traversing said selective opacity display and impinging on said optical elements of said subarray display circuits within said combination imager and selective backlight;
communicating light emission instructions and information about detected light through said plurality of communications channels between neighboring subarray display circuits within said combination imager and selective backlight.

18. An apparatus as recited in claim 17, wherein said plurality of optical elements comprise light emitting diodes;
wherein at least a portion of said light emitting diodes are disposed on said subarray display circuit for selectively registering light intensity or light emission.

19. An apparatus as recited in claim 17, wherein said selective opacity display comprises a liquid crystal display (LCD).

20. An apparatus as recited in claim 17, wherein said apparatus comprises an infra-extensible combination imager and selective backlight in which the number of processors for performing said programming and the number of communication channels available through which said light emission instruction can be received, increases automatically in response to increasing the number of subarray display circuits within said combination imager and selective backlight.
